(19) United States
(12) Patent Application Publication
(10) Pub. No.: US 2020/0194745 A1
(43) Pub. Date: Jun. 18, 2020

(54) MOBILE POWER FOR OUTDOOR POWER SUPPLY

(71) Applicants: Zhejiang Geely Holding Group Co., Ltd., Hangzhou City, Zhejiang Province (CN); Zhejiang Geely Automobile Research Institute Co., Ltd, Taizhou City, Zhejiang Province (CN)

(72) Inventor: SHUFU LI, Hangzhou City, Zhejiang Province (CN)

(21) Appl. No.: 16/623,390

(22) PCT Filed: Jun. 14, 2018
(86) PCT No.: PCT/CN2018/091216

§ 371 Date: Dec. 16, 2019

(30) Foreign Application Priority Data
Jun. 15, 2017 (CN) 201710453148.4

(51) Int. Cl. H01M 2/10; H02J 50/10; H02J 50/60; H02J 50/90; H02J 7/00

(52) U.S. Cl. CPC H01M 2/1022; H02J 50/10; G06K 19/025; H02J 50/90; H02J 7/0042; H02J 50/60

(57) ABSTRACT

A mobile power for outdoor power supply includes a power housing, a battery pack, a driving device, a controller and a tracking device. The battery pack is disposed inside the power housing. The power housing is provided with at least one socket electrically connected with the battery pack. The battery pack is used to supply electric power to an electric tool during outdoor work through the socket. The driving device includes wheels and driving motors for driving the wheels. The controller is connected with the driving motors. The tracking device is connected with the controller. The tracking device is used to track the user of the mobile power. The controller controls the driving device to drive the power housing to automatically follow the user according to the tracking result of the tracking device. The mobile power is suitable for power supply for high-power electric tools during outdoor work.

### CROSS-REFERENCE TO RELATED APPLICATION

The present application is based on and claims the priority of Chinese patent application No. 201710453148.4, filed on Jun. 15, 2017. The entire disclosure of the above-identified application is incorporated herein by reference.

### TECHNICAL FIELD

The present application relates to mobile power, and particularly to a mobile power for outdoor power supply.

### BACKGROUND ART

In outdoor agriculture and forestry work, various tools are often used, such as saws, blowers, pumps, lawn mowers, etc. These tools usually are divided into two types, one type using internal combustion engines and the other type using electricity. In recent years, considerable progress has been made in battery technology, and a variety of rechargeable electric tools have appeared, for example, electric saws, electric lawn mowers, etc. Rechargeable electric tools are popular because of the advantages of lightness, energy saving and environmental protection, low noise, and easy maintenance.

### TECHNICAL PROBLEM

However, the power of rechargeable electric tools is relatively small. In some working environments, the rechargeable electric tools with small power may not be used. If a high-power electric tool is used, the battery of such an electric tool will be heavy, and the electric tool with the heavy battery will be difficult to be carried. Although plug-in electric tools are of high power, they are limited to power supply and cannot be used outdoors.

With the development of battery technology, motor technology and electronic control technology, not only the technology of lithium battery is mature, but also the price is getting lower and lower. If there is a kind of mobile power which can work outdoors and is easy to carry and transport, it not only can satisfy the need of high-power electric tools during outdoor work, but also help to improve the quality of working environment for the s, to reduce labor intensity and reduce environmental pollution.

### TECHNICAL SOLUTION

In view of the above, the present application provides a mobile power for outdoor power supply. The mobile power can move on its own, easy to transport, and is provided with a large capacity battery. Therefore, the mobile power is suitable for power supply for high-power electric tools during outdoor work.

In an embodiment, the present application provides a mobile power for outdoor power supply, which includes a power housing, a battery pack, a driving device, a controller and a tracking device. The battery pack is disposed inside the power housing. The power housing is provided with at least one socket electrically connected with the battery pack. The battery pack is used to supply electric power to an electric tool during outdoor work through the socket. The driving device includes wheels and driving motors for driving the wheels. The controller is connected with the driving motors. The tracking device is connected with the controller. The tracking device is used to track the user of the mobile power. The controller controls the driving device to drive the power housing to automatically follow the user according to the tracking result of the tracking device.

In an embodiment, the present application further provides a mobile power for outdoor power supply, which includes a power housing, a battery pack, a driving device, a controller and an instruction receiving module. The battery pack is disposed inside the power housing. The power housing is provided with at least one socket electrically connected with the battery pack. The battery pack is used to supply electric power to an electric tool during outdoor work through the socket. The driving device includes wheels and driving motors for driving the wheels. The controller is connected with the driving motors. The instruction receiving module is connected with the controller. The instruction receiving module is used to receive instructions of the user. The controller controls the driving device to drive the power housing to move according to the instructions received by the instruction receiving module.

### Advantageous Effects

The mobile power provided by the embodiments of the present application can automatically follow the user or can move under the manipulations of the user. Therefore, plug-in type high power electric tool can be used, and no battery is required to install in the electric tool, so that the weight of the electric tool is greatly reduced. The quantity of the battery pack in the power housing can be selected according to the need of power and consumption of electricity. Since the battery pack does not need manual movement, the labor intensity of the worker is greatly reduced, to thereby solve the problem that the battery pack is too heavy and inconvenient to carry. Since the mobile power can move on its own, it can be used conveniently for power supply to various electric tools during outdoor work.

### DESCRIPTION OF DRAWINGS

FIG. 1 is a front view of a mobile power according to an embodiment of the present application.

FIG. 2 is a side view of the mobile power of FIG. 1.

FIG. 3 is a side view of the mobile power of FIG. 1 by removing the side plate and opening the top plate.

FIG. 4 is a top view of the mobile power of FIG. 1 by removing the top plate.

FIG. 5 is a view showing that the mobile power of FIG. 1 is connected with an electric tool for power supply.

FIG. 6 is a side view of a mobile power according to another embodiment of the present application.

FIG. 7 is a block diagram of a mobile power according to an embodiment of the present application.

FIG. 8 is a block diagram of the tracking device according to an example of the present application.

FIG. 9 is a block diagram of the tracking device according to another example of the present application.

FIG. 10 is a block diagram of the tracking device according to another example of the present application.

FIG. 11 is a block diagram of the tracking device according to a further example of the present application.

FIG. 12 is a block diagram of a mobile power according to another embodiment of the present application.

FIG. 13 is a block diagram of a mobile power according to another embodiment of the present application.

FIG. 14 is a block diagram of a mobile power according to another embodiment of the present application.

FIG. 15 is a block diagram of a mobile power according to a further embodiment of the present application.

FIG. 16 is a side view of a mobile power according to another embodiment of the present application.

FIG. 17 is a side view of a mobile power according to another embodiment of the present application.

### MODE FOR INVENTION

In order to make the purposes, characteristics, and advantages of the present application more apparently, embodiments of the present application will now be described in more detail with reference to the drawing figures.

Referring from FIG. 1 to FIG. 5, a mobile power 100 for outdoor power supply is provided in an embodiment of the present application. The mobile power 100 includes a power housing 101, a battery pack 102, a driving device 110, a controller 103, and a tracking device 120. The battery pack 102 is disposed inside the power housing 101. The power housing 101 is provided with at least one socket 104 electrically connected with the battery pack 102. The battery pack 102 can supply electric power to an electric tool 200 during outdoor work through the socket 104. The driving device 110 includes wheels 111 and driving motors 112 for driving the wheels 111. The controller 103 is connected with the driving motors 112. The tracking device 120 is connected with the controller 103. The tracking device 120 is used to track the user of the mobile power 100 (i.e., the worker), the controller 103 controls the driving motors 112 to operate according to the tracking result of the tracking device 120, and accordingly the driving motors 112 drive the wheels 111 to rotate, so that the power housing 101 is driven to automatically follow the user to keep the distance between the power housing 101 and the user in a preset range. The preset range is, for example, 2-6 meters. By keeping the power housing 101 at a certain distance from the user, the working space is not occupied by the power housing 101, which is conducive to improving the convenience during outdoor work.

In the embodiment, the tracking device 120 can detect the distance between the power housing 101 and the user. When the tracking device 120 detects that the distance between the power housing 101 and the user is within the range of 2-6 meters, the controller 103 controls the driving device 110 to stop, and accordingly the power housing 101 stands still. Hence, even if the user moves in a small range, as long as the distance between the power housing 101 and the user is still within the range of 2-6 meters, the power housing 101 may stand still without following the movement of the user, in order to minimize the movement of the power housing 101 and reduce the power consumption of the mobile power 100. When the tracking device 120 detects that the distance between the power housing 101 and the user is beyond the range of 2-6 meters, the controller 103 immediately controls the driving device 110 to operate in order to drive the power housing 101 to follow the user, until the distance between the power housing 101 and the user reaches the range of 2-6 meters. Thus, by automatically tracking the user, the distance between the power housing 101 and the user is always within the preset range of 2-6 meters.

In the embodiment, under the control of the tracking device 120 and the controller 103, the power housing 101 which carries the battery pack 102 can follow the user automatically. That is, where the user goes, where the power housing 101 follows. Therefore, plug-in type high power electric tool 200 can be used, and no battery is required to install in the electric tool 200, so that the weight of the electric tool 200 is greatly reduced. The quantity of the battery pack 102 in the power housing 101 can be selected according to the need of power and consumption of electricity. Since the battery pack 102 does not need manual movement, the labor intensity of the worker is greatly reduced, to thereby solve the problem that the battery pack 102 is too heavy and inconvenient to carry. Since the mobile power 100 can move on its own, it can be used conveniently for power supply to various electric tools 200 during outdoor work.

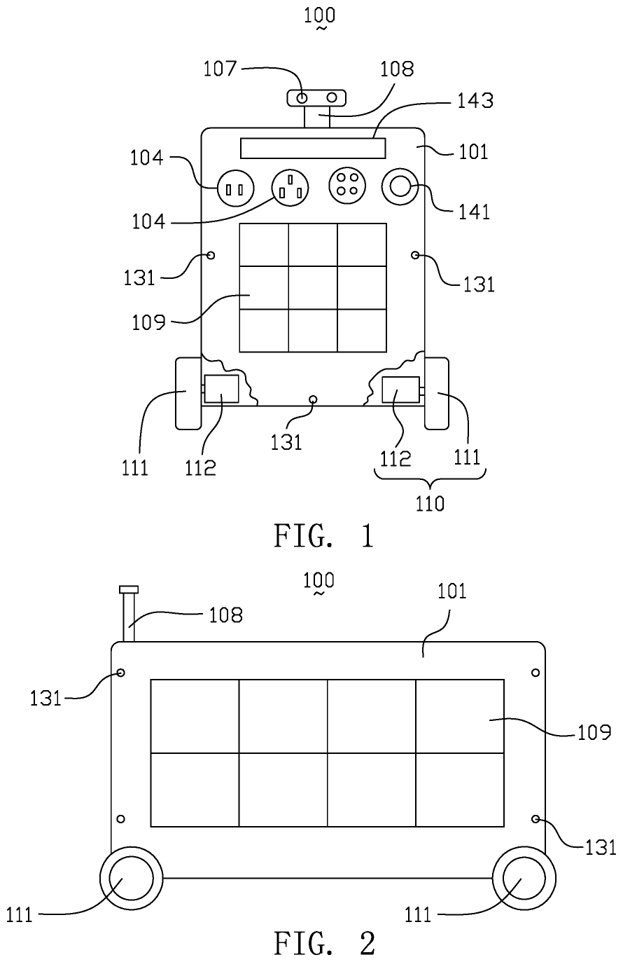

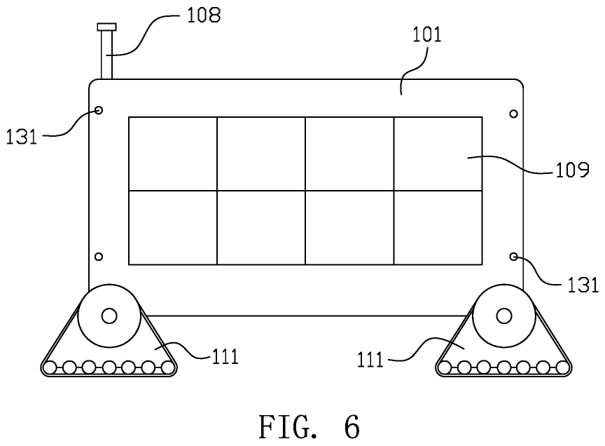

Specifically, the driving device 110 is provided at the bottom of the power housing 101. The driving device 110 may include four wheels 111, and the four wheels 111 may include driving wheels and driven wheels, wherein two wheels 111 may be driving wheels and the other two wheels 111 may be driven wheels. Each driving wheel is driven correspondingly by a driving motor 112. Each driving motor 112 is powered by the battery pack 102 in the power housing 101. Furthermore, the wheels 111 are detachably mounted to the power housing 101, which is conducive to changing the type of the wheels 111, so that the mobile power 100 can adapt to different roads, to improve the adaptability to working environments. In one embodiment, as shown in FIG. 1 and FIG. 2, the wheels 111 may be inflatable wheels or solid wheels, to adapt for relatively flat roads. In another embodiment, as shown in FIG. 6, the wheels 111 may be crawler wheels, to adapt for roads having potholes or slopes.

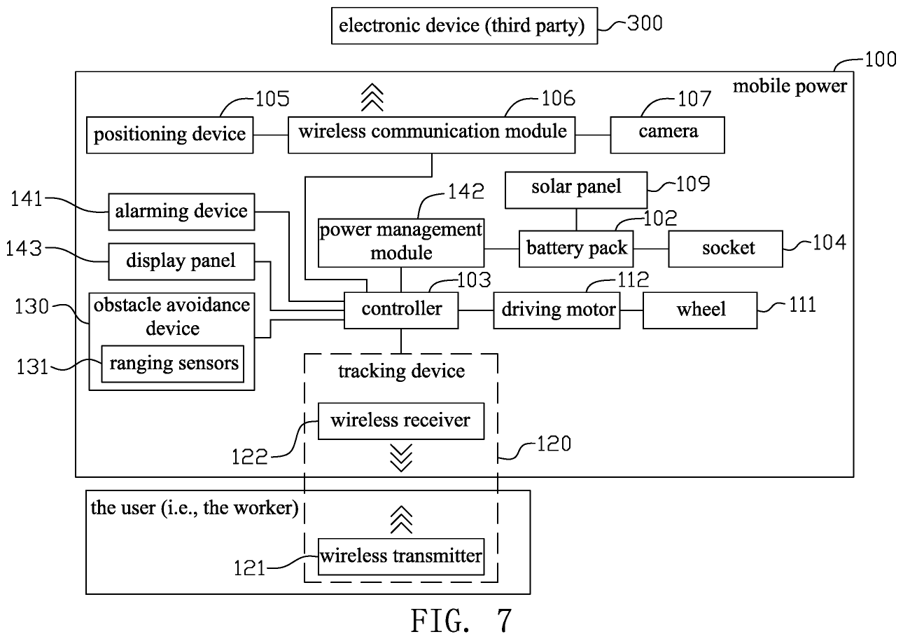

In the embodiment, as shown in FIG. 7, the tracking device 120 includes a wireless transmitter 121 and a wireless receiver 122, one of the wireless transmitter 121 and the wireless receiver 122 is carried by the user, and the other one of the wireless transmitter 121 and the wireless receiver 122 is carried by the power housing 101. For example, the wireless transmitter 121 is carried by the user, and the wireless receiver 122 is carried by the power housing 101, but it is not limited thereto. Furthermore, the wireless transmitter 121 may be integrated in a smart phone or a smart wearable device of the user, wherein the smart wearable device may be a smart watch, a smart hand ring, etc. Of course, the wireless transmitter 121 may also be provided independently.

The wireless receiver 122 receives signals sent from the wireless transmitter 121, and the tracking device 120 detects a distance between the power housing 101 and the user based on the signal intensity received by the wireless receiver 122, to realize tracking the user automatically. In order to track the user, the tracking device 120 may use the theory of locating based on received signal strength indicator (RSSI). In the theory of RSSI locating, the intensity of signals emitted by the emitting node (i.e., the wireless transmitter 121) is known, the receiving node (i.e., the wireless receiver 122) calculates the attenuation of the signals in the process of transmission based on the intensity of the received signals, and the distance between the two nodes is calculated out according to the relationship between the signal attenuation and the transmission distance.

Specifically, the tracking device 120 may use at least one of the following tracking and locating technologies, including WiFi, bluetooth, ultrared, ultrasonic, GPS, RFID, and ZigBee. Thus, the wireless transmitter 121 and the wireless receiver 122 may be WiFi module, bluetooth module, infrared module, ultrasonic module, GPS module, RFID module, or ZigBee module.

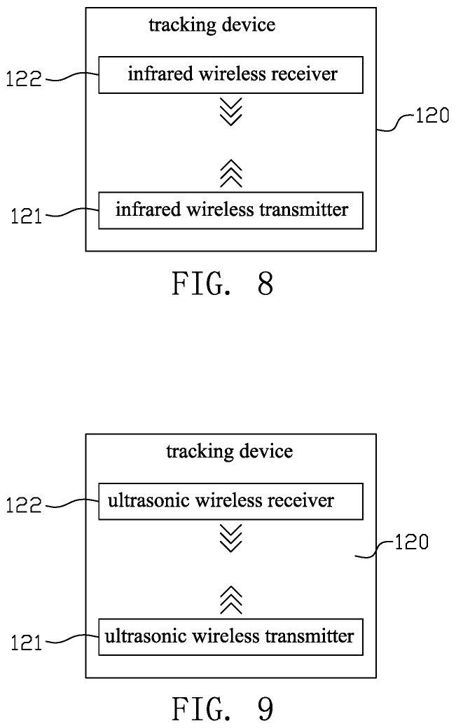

In a specific example, as shown in FIG. 8, the wireless transmitter 121 is an infrared wireless transmitter, and the wireless receiver 122 is an infrared wireless receiver. In use, the infrared wireless transmitter 121 is carried by the user, and the infrared wireless receiver 122 is carried by the power housing 101. The infrared wireless transmitter 121 sends infrared signals automatically to the power housing 101 for locating. The infrared wireless receiver 122 in the power housing 101 receives the infrared signals sent by the infrared wireless transmitter 121 from the user, and the location of the user is obtained in real time based on RSSI. Thereafter, the controller 103 regulates the moving speed and direction of the power housing 101 and controls the power housing 101 to automatically follow the user.

In another specific example, as shown in FIG. 9, the wireless transmitter 121 is an ultrasonic wireless transmitter, and the wireless receiver 122 is an ultrasonic wireless receiver. In use, the ultrasonic wireless transmitter 121 is carried by the user, and the ultrasonic wireless receiver 122 is carried by the power housing 101. The ultrasonic wireless transmitter 121 sends ultrasonic signals automatically to the power housing 101 for locating. The ultrasonic wireless receiver 122 in the power housing 101 receives the ultrasonic signals sent by the ultrasonic wireless transmitter 121 from the user, and the location of the user is obtained in real time based on RSSI. Thereafter, the controller 103 regulates the moving speed and direction of the power housing 101 and controls the power housing 101 to automatically follow the user.

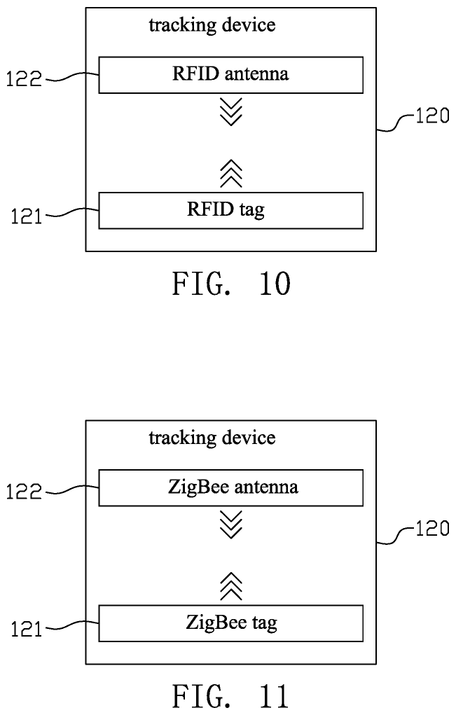

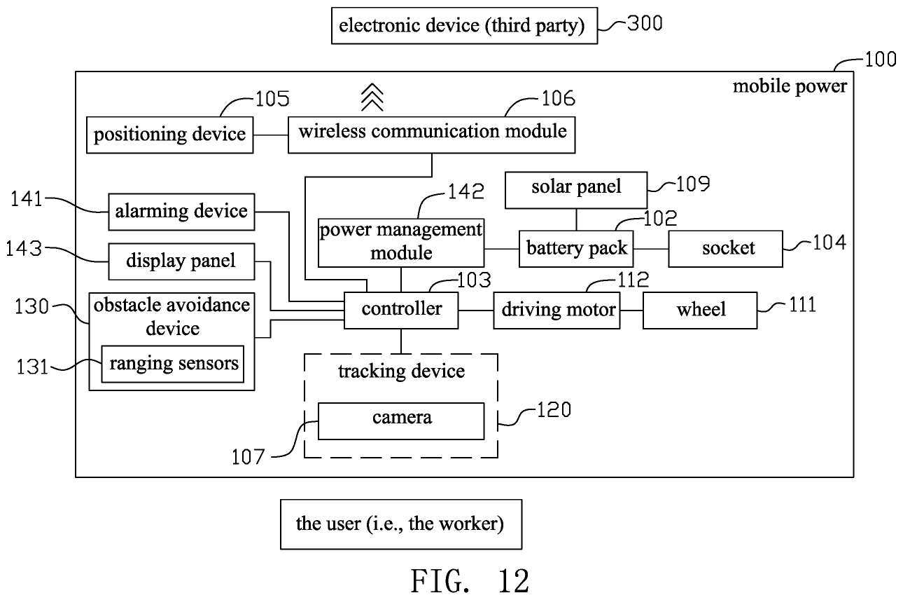

In another specific example, as shown in FIG. 10, the wireless transmitter 121 is a RFID (radio frequency identification) tag, and the wireless receiver 122 is a RFID antenna. In use, the RFID tag 121 is carried by the user, and the RFID antenna 122 is carried by the power housing 101. The RFID tag 121 sends signals automatically to the power housing 101 for locating. The RFID antenna 122 in the power housing 101 receives the signals sent by the RFID tag 121 from the user, and the location of the user is obtained in real time based on RSSI. Thereafter, the controller 103 regulates the moving speed and direction of the power housing 101 and controls the power housing 101 to automatically follow the user.

In a further specific example, as shown in FIG. 11, the wireless transmitter 121 is a ZigBee tag, and the wireless receiver 122 is a ZigBee antenna. In use, the ZigBee tag 121 is carried by the user, and the ZigBee antenna 122 is carried by the power housing 101. The ZigBee tag 121 sends signals automatically to the power housing 101 for locating. The ZigBee antenna 122 in the power housing 101 receives the signals sent by the ZigBee tag 121 from the user, and the location of the user is obtained in real time based on RSSI. Thereafter, the controller 103 regulates the moving speed and direction of the power housing 101 and controls the power housing 101 to automatically follow the user.

As shown in FIG. 7, the mobile power 100 further includes an obstacle avoidance device 130, and the obstacle avoidance device 130 is connected with the controller 103. The obstacle avoidance device 130 can detect the obstacles existed in a surrounding environment of the power housing 101. In the course of tracking the user, the controller 103 controls the power housing 101 to keep away from the obstacles according to the detected obstacle information. By using the obstacle avoidance device 130 to detect the obstacle information in the surrounding environment of the power housing 101, the power housing 101 can realize the function of active collision prevention, which greatly improves the safety in the course of automatically tracking the user.

The obstacle avoidance device 130 includes a plurality of ranging sensors 131, and the ranging sensors 131 are distributed over the outer surfaces of the power housing 101, as shown in FIGS. 1-2. Specifically, the ranging sensor 112 may be selected from infrared ranging sensor, ultrasonic ranging sensor, laser ranging sensor, and microwave radar ranging sensor. Since the ranging sensors 131 are distributed on the outer surfaces of the power housing 101, the ranging sensors 131 can sense the obstacles around the power housing 101. The distance measurement theory of the ranging sensor 131 is as follows. A propagation speed of a wireless signal (e.g., infrared, ultrasonic, laser, microwave) emitted by the ranging sensor 131 is known in the air, the time is measured when the wireless signal is reflected back after emission, and the actual distance between the emitting point and the obstacle is calculated based on the time difference between the emission and the reception of the signal.

As shown in FIG. 7, the mobile power 100 further includes a positioning device 105 and a wireless communication module 106. The positioning device 105 is used to obtain the current position of the mobile power 100, and the wireless communication module 106 sends the current position information of the mobile power 100 to an electronic device 300 of a third party (e.g., the manager responsible for the outdoor work). The positioning device 105 can be global positioning system (GPS) or Beidou positioning system. The power housing 101 can be positioned in real time through the positioning device 105, and the current position information of the mobile power 100 can be sent to the electronic device 300 wirelessly. It is understood that, there is also a wireless communication module (not shown) on the electronic device 300 to receive the positioning data sent by the wireless communication module 106 of the mobile power 100, such that the manager can understand the current position and the working progress of the mobile power 100 whenever necessary.

As shown in FIG. 7, the mobile power 100 further includes a camera 107. The camera 107 is used to capture the images surrounding the power housing 101. The wireless communication module 106 sends the images captured by the camera 107 to an electronic device 300 of a third party (e.g., the manager responsible for the outdoor work). The onsite working progress of the worker can be captured by the camera 107, and the captured images can be sent to the electronic device 300 wirelessly, such that the manager can understand the onsite working progress conveniently, which is conducive to realizing work scheduling and statistical management among different workers.

Referring to FIGS. 1-2, the mobile power 100 further includes a mounting pole 108. The mounting pole 108 is provided on the power housing 101, and the camera 107 is mounted on the mounting pole 108. Preferably, the mounting pole 108 is telescopically mounted to the power housing 101, so that the mounting pole 108 extends out of the power housing 101 or is embedded in the power housing 101. When the mounting pole 108 is embedded in the power housing 101, the electronic components (e.g., the camera 107) on the mounting pole 108 are protected, to realize waterproof, dustproof, collision protection.

As shown in FIG. 7, the mobile power 100 further includes a solar panel 109. The solar panel 109 is provided on the outer surfaces of the power housing 101. The solar panel 109 is electrically connected with the battery pack 102. In outdoor work, the battery pack 102 can be charged by the solar panel 109, to improve power endurance of the mobile power 100. Referring to FIGS. 1-2, the solar panel 109 is provided on the circumferential outer surfaces of the power housing 101, and the solar panel 109 can be folded and stretched, in order to increase the effective area of the solar panel 109.

As shown in FIG. 7, the mobile power 100 further includes an alarming device 141. The alarming device 141 is connected with the controller 103. The alarming device 141 can provide an alarming function. When the automatic tracking function of the power housing 101 is abnormal or the system has other faults, it will automatically alarm. The alarming device 141 can be a loudspeaker alarm or a sound-light alarm.

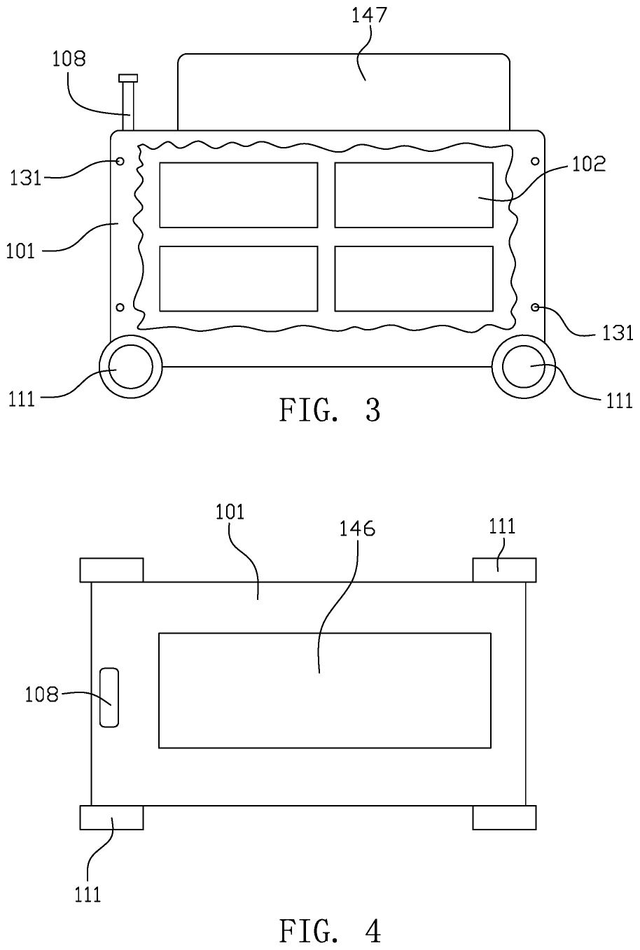

Referring to FIGS. 3-4, the power housing 101 is defined with a storage tank 146 for accommodating articles including the electric tool 200. The storage tank 146 may be defined in the top surface of the power housing 101, but it is not limited thereto. The storage tank 146 may also be defined in other positions of the power housing 101 (e.g., the side surfaces of the power housing 101). There is provided with a cover plate 147 above the storage tank 146, and by opening the cover plate 147, the articles can be put into or taken out from the storage tank 146. In this way, during the non-working time (such as going to the job site or returning home), the electric tool 200 can be carried by the power housing 101 in the storage tank 146, and it is not necessary to carry the electric tool 200 manually, further reducing the labor intensity of the worker.

Referring to FIG. 1, the socket 104 provided on the power housing 101 may be multiple. The multiple sockets 104 have different types or different output voltages, such that the mobile power 100 can be adapted to electric tools 200 with different joint types or different working voltages, to improve the versatility of the mobile power 10.

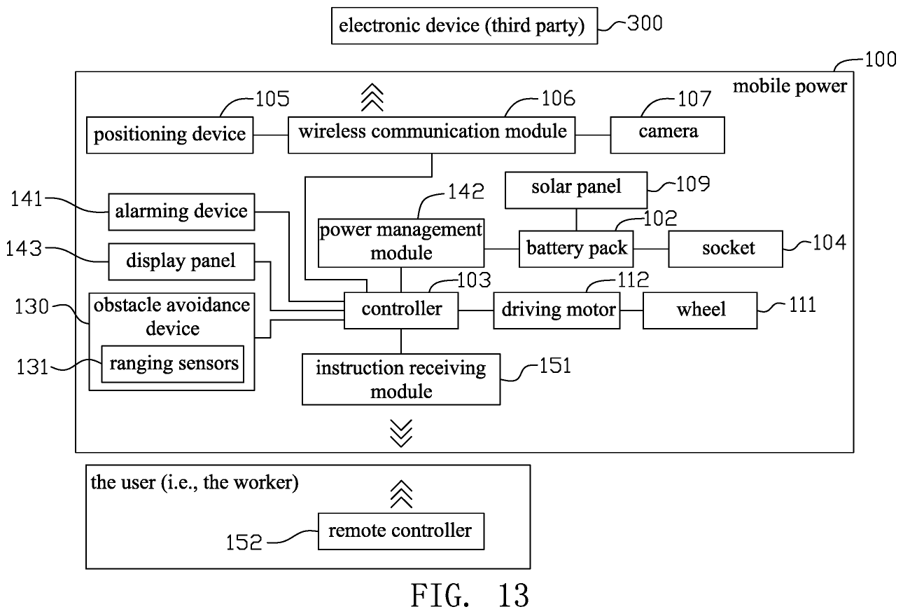

FIG. 12 provides a mobile power 100 for outdoor power supply according to another embodiment. As shown in FIG. 12, the tracking device 120 includes a camera 107, and the camera 107 is used to capture the images of the user (i.e., the worker), to realize tracking the user automatically through image recognition. In this way, the tracking device 120 tracks the target (i.e., the worker) by using the camera 107, so that the user does not need to wear any auxiliary equipment, to improve the convenience of the outdoor work. In the embodiment, on one hand, the camera 107 is used to track the working worker, and on the other hand, the image information captured by the camera 107 may also be sent to an electronic device 300 of a third party through the wireless communication module 106 to facilitate the manager to understand the working progress on the spot.

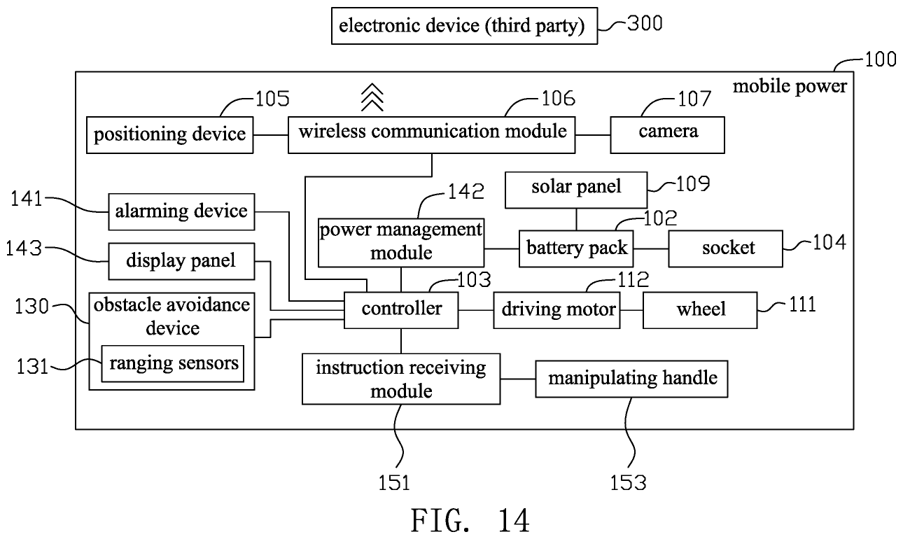

FIG. 13 provides a mobile power 100 for outdoor power supply according to another embodiment. The mobile power 100 includes a power housing 101, a battery pack 102, a driving device 110, a controller 103, and an instruction receiving module 151. The battery pack 102 is disposed inside the power housing 101. The power housing 101 is provided with at least one socket 104 electrically connected with the battery pack 102. The battery pack 102 can supply electric power to an electric tool 200 during outdoor work through the socket 104. The driving device 110 includes wheels 111 and driving motors 112 for driving the wheels 111. The controller 103 is connected with the driving motors 112. The instruction receiving module 151 is connected with the controller 103. The instruction receiving module 151 is used to receive instructions of the user (i.e., the worker), the controller 103 controls the driving motors 112 to operate according to the instructions received by the instruction receiving module 151, and accordingly the driving motors 112 drive the wheels 111 to rotate, so that the power housing 101 is driven to move under the instructions of the user.

As shown in FIG. 13, the mobile power 100 further includes a remote controller 152. The remote controller 152 is matched with the instruction receiving module 151. The instruction receiving module 151 can receive the instructions sent by the user through the remote controller 152. The instruction receiving module 151 sends the received instructions to the controller 103, and the controller 103 controls the driving device 110 to drive the power housing 101 to move according to the instructions of the user.

Specifically, the remote controller 152 is carried by the user. When needing the power housing 101 to move, the user sends the instructions, such as moving forward, moving back, turning left, or turning right, to the instruction receiving module 151 through the remote controller 152. The instruction receiving module 151 receives these instructions and transfers them to the controller 103, and accordingly the controller 103 controls the driving device 110 to drive the power housing 101 to move. In this way, the user only needs to carry the remote controller 152, and remotely controls the power housing 101 by using the remote controller 152. Therefore, plug-in type high power electric tool 200 can be used, and no battery is required to install in the electric tool 200, so that the weight of the electric tool 200 is greatly reduced. The quantity of the battery pack 102 in the power housing 101 can be selected according to the need of power and consumption of electricity. Since the battery pack 102 does not need manual movement, the labor intensity of the worker is greatly reduced, to thereby solve the problem that the battery pack 102 is too heavy and inconvenient to carry. Since the mobile power 100 can move on its own, it can be used conveniently for power supply to various electric tools 200 during outdoor work.

For other structures of the embodiment of FIG. 13, reference can be made to the above, and they are omitted here for clarity.

FIG. 14 provides a mobile power 100 for outdoor power supply according to another embodiment. The mobile power 100 includes a power housing 101, a battery pack 102, a driving device 110, a controller 103, and an instruction receiving module 151. The battery pack 102 is disposed inside the power housing 101. The power housing 101 is provided with at least one socket 104 electrically connected with the battery pack 102. The battery pack 102 can supply electric power to an electric tool 200 during outdoor work through the socket 104. The driving device 110 includes wheels 111 and driving motors 112 for driving the wheels 111. The controller 103 is connected with the driving motors 112. The instruction receiving module 151 is connected with the controller 103. The instruction receiving module 151 is configured to receive the instructions of the user (i.e., the worker), the controller 103 controls the driving motors 112 to operate according to the instructions received by the instruction receiving module 151, and accordingly the driving motors 112 drive the wheels 111 to rotate, so that the power housing 101 is driven to move under the instructions of the user.

As shown in FIG. 14, the mobile power 100 further includes a manipulating handle 153. The manipulating handle 153 is provided on the power housing 101. The manipulating handle 153 is connected with the instruction receiving module 151. The instruction receiving module 151 can receive the instructions sent by the user through the manipulating handle 153. The instruction receiving module 151 then sends the received instructions to the controller 103, and the controller 103 controls the driving device 110 to drive the power housing 101 to move according to the instructions of the user.

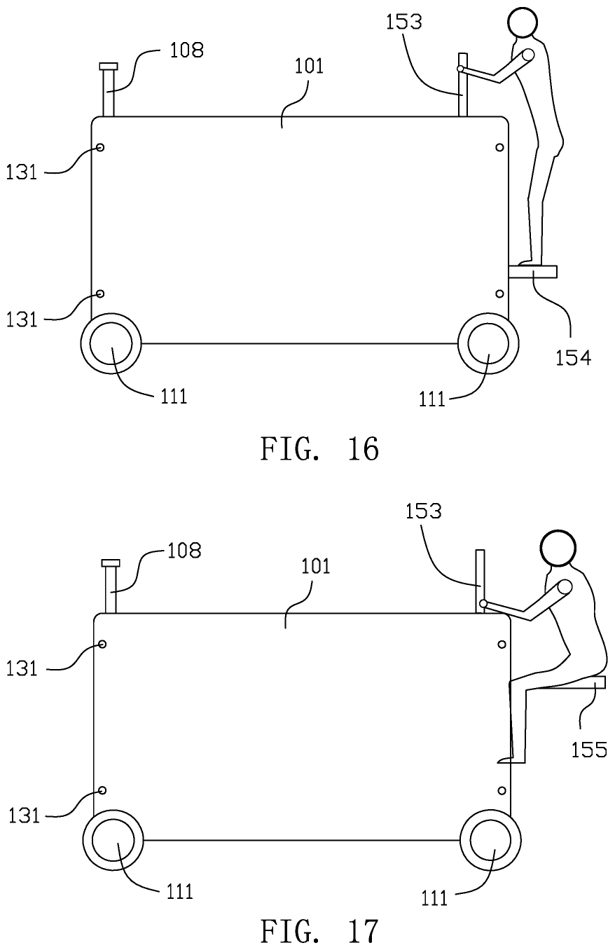

Referring to FIGS. 16-17, the manipulating handle 153 is provided on, for example, the top surface of the power housing 101 to facilitate manipulations for the user. The manipulating handle 153 can be provided independently, or be integrated with the above mounting pole 108.

Further, the mobile power 100 further includes a pedal plate 154, and the pedal plate 154 is provided on the power housing 101 for the user to stand on (as shown in FIG. 16). Alternatively, the mobile power 100 further includes a seat plate 155, and the seat plate 155 is provided on the power housing 101 for the user to sit on (as shown in FIG. 17). When needing the power housing 101 to move, the user sends the instructions, such as moving forward, moving back, turning left, or turning right, to the instruction receiving module 151 through the manipulating handle 153. The instruction receiving module 151 receives these instructions and transfers them to the controller 103, and accordingly the controller 103 controls the driving device 110 to drive the power housing 101 to move. In this way, the user only needs to stand on the pedal plate 154 or sit on the seat plate 155 to manually manipulate the manipulating handle 153, to directly control the power housing 101 to move by using the manipulating handle 153. Therefore, plug-in type high power electric tool 200 can be used, and no battery is required to install in the electric tool 200, so that the weight of the electric tool 200 is greatly reduced. The quantity of the battery pack 102 in the power housing 101 can be selected according to the need of power and consumption of electricity. Since the battery pack 102 does not need manual movement, the labor intensity of the worker is greatly reduced, to thereby solve the problem that the battery pack 102 is too heavy and inconvenient to carry. Since the mobile power 100 can move on its own, it can be used conveniently for power supply to various electric tools 200 during outdoor work. Further, in this embodiment, when the user is tired after finishing the outdoor work, the user can return home by riding the power housing 101, which is very convenient and can reduce tiredness for the user.

For other structures of the embodiment of FIG. 14, reference can be made to the above, and they are omitted here for clarity.

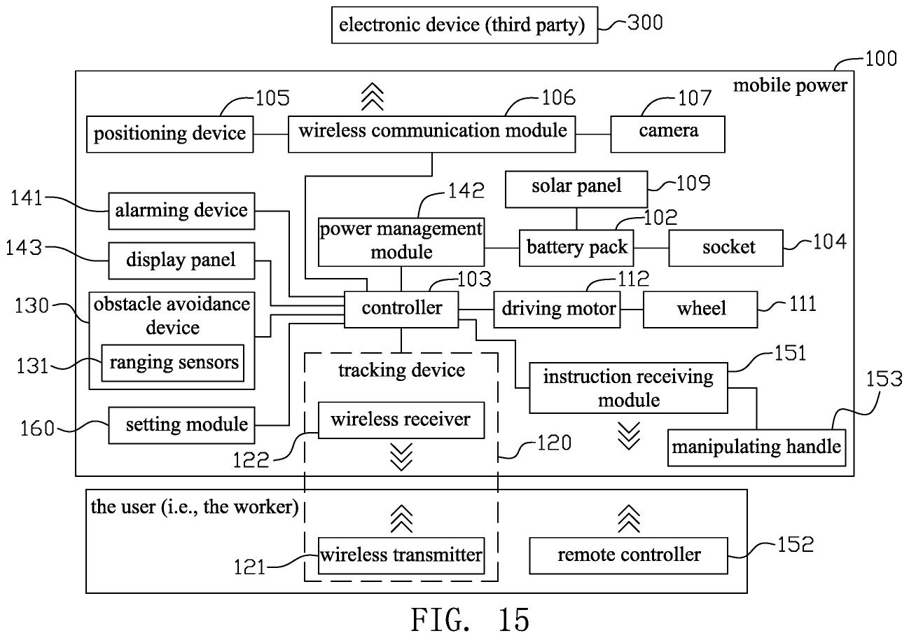

FIG. 15 provides a mobile power 100 for outdoor power supply according to a further embodiment. The mobile power 100 is integrated with all of the functions of the embodiments of FIG. 7, FIG. 13 and FIG. 14. That is, the mobile power 100 includes a tracking device 120, an obstacle avoidance device 130, an instruction receiving module 151, a remote controller 152, and a manipulating handle 153. Further, the mobile power 100 includes a setting module 160 configured for the user to set the moving mode of the mobile power 100. The moving mode of the mobile power 100 includes automatic tracking mode and manual manipulation mode. When the mobile power 100 is set with the automatic tracking mode by the setting module 160, the controller 103 controls the power housing 101 to automatically follow the user according to the detecting result of the tracking device 120. When the mobile power 100 is set with the manual manipulation mode by the setting module 160, the controller 103 controls the power housing 101 to move under the manipulations of the user according to the instructions received by the instruction receiving module 151. Therefore, the user can select the automatic tracking mode or the manual manipulation mode by the setting module 160 according to actual requirement. For example, during the outdoor work, the user can choose the automatic tracking mode for the roads with good road condition, such that the power housing 101 can follow the user automatically, without the need of manipulating the power housing 101 to move by the user. For the roads with poor road condition, the user can choose the manual manipulation mode, such that the user can manually select the moving paths of the power housing 101 to improve the moving efficiency. In addition, after finishing the outdoor work, the user can also choose the manual manipulation mode, such that the user can return home by riding the power housing 101, which is very convenient and can reduce tiredness for the user.

Further, the mobile power 100 further includes a power management module 142 configured for calculating the remaining endurance capacity of the battery pack 102 according to the electricity consumption rate and the residual electricity amount. The remaining endurance capacity of the battery pack 102 can be represented by the remaining mileage or the rest time capable of suppling power.

Further, the mobile power 100 further includes a display panel 143. The display panel 143 can be provided on a surface of the power housing 101, as shown in FIG. 1. The display panel 143 can be used to display the electricity consumption status of the battery pack 102, the moving mode of the mobile power 100, and the working state of various components.

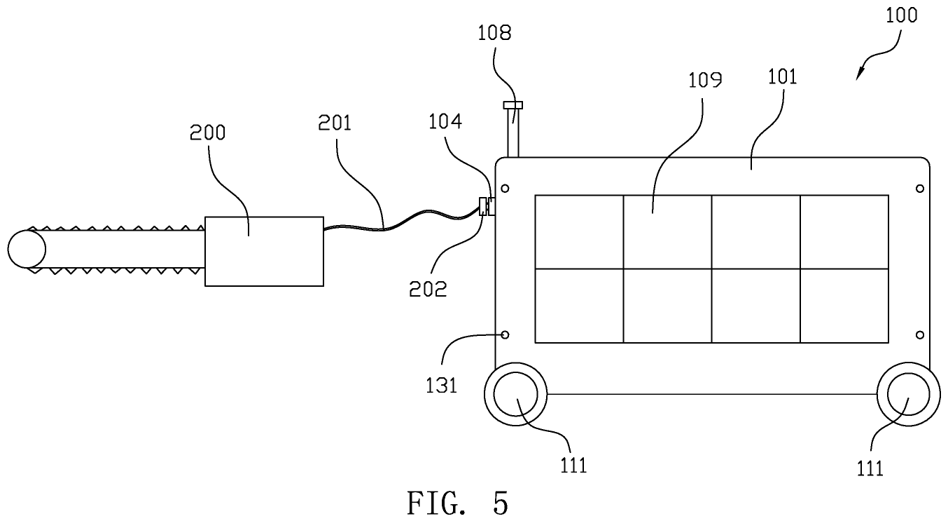

As shown in FIG. 5, when the mobile power 100 is used in the outdoors, the electric tool 200 is connected to the socket 104 of the mobile power 100 through cable 201 and plug 202, so that the mobile power 100 can supply power for the electric tool 200 during outdoor work. Specifically, the electric tool 200 may be electric saws, blowers, pumps, lawn mowers, etc.

The above are embodiments of the present application only, and should not be deemed as limitations to the present application. Although the present application has been disclosed in embodiments as above, it is not intended to limit the present application. It should be noted that variations and improvements will become apparent to those skilled in the art to which the present application pertains. Therefore, the scope of the present application is defined by the appended claims.

### INDUSTRIAL APPLICABILITY

The mobile power provided by the embodiments of the present application can automatically follow the user or can move under the manipulations of the user. Therefore, plug-in type high power electric tool can be used, and no battery is required to install in the electric tool, so that the weight of the electric tool is greatly reduced. The quantity of the battery pack in the power housing can be selected according to the need of power and consumption of electricity. Since the battery pack does not need manual movement, the labor intensity of the worker is greatly reduced, to thereby solve the problem that the battery pack is too heavy and inconvenient to carry. Since the mobile power can move on its own, it can be used conveniently for power supply to various electric tools during outdoor work.

1. A mobile power for outdoor power supply, comprising a power housing, a battery pack, a driving device, a controller and a tracking device, wherein the battery pack is disposed inside the power housing, the power housing is provided with at least one socket electrically connected with the battery pack, the battery pack is used to supply electric power to an electric tool during outdoor work through the socket, the driving device includes wheels and driving motors for driving the wheels, the controller is connected with the driving motors, the tracking device is connected with the controller, the tracking device is used to track the user of the mobile power, the controller controls the driving device to drive the power housing to automatically follow the user according to the tracking result of the tracking device.

2. The mobile power of claim 1, wherein the tracking device includes a wireless transmitter and a wireless receiver, one of the wireless transmitter and the wireless receiver is carried by the user, the other one of the wireless transmitter and the wireless receiver is carried by the power housing, the wireless receiver receives the signals sent from the wireless transmitter, the tracking device detects a distance between the power housing and the user based on the signal intensity received by the wireless receiver to realize tracking the user automatically.

3. The mobile power of claim 2, wherein the wireless transmitter is carried by the user, the wireless receiver is carried by the power housing.

4. The mobile power of claim 1, wherein the tracking device includes a camera, the camera is used to capture the images of the user to realize tracking the user automatically through image recognition.

5. The mobile power of claim 1, wherein the mobile power further comprises an obstacle avoidance device, the obstacle avoidance device is connected with the controller, the obstacle avoidance device is used to detect the obstacles existed in a surrounding environment of the power housing, the controller controls the power housing to keep away from the obstacles according to the detecting result of the obstacle avoidance device.

6. The mobile power of claim 5, wherein the obstacle avoidance device includes a plurality of ranging sensors, and the ranging sensors are distributed over the outer surfaces of the power housing.

7. The mobile power of claim 1, wherein the mobile power further comprises an instruction receiving module, the instruction receiving module is connected with the controller, the instruction receiving module is used to receive instructions of the user, the controller controls the driving device to drive the power housing to move according to the instructions received by the instruction receiving module.

8. The mobile power of claim 7, wherein the mobile power further comprises a remote controller, the remote controller is matched with the instruction receiving module, the instruction receiving module receives the instructions sent by the user through the remote controller, the instruction receiving module sends the received instructions to the controller, the controller controls the driving device to drive the power housing to move according to the instructions of the user.

9. The mobile power of claim 7, wherein the mobile power further comprises a manipulating handle, the manipulating handle is provided on the power housing, the manipulating handle is connected with the instruction receiving module, the instruction receiving module receives the instructions sent by the user through the manipulating handle, the instruction receiving module sends the received instructions to the controller, the controller controls the driving device to drive the power housing to move according to the instructions of the user.

10. The mobile power of claim 7, wherein the mobile power further comprises a setting module configured for the user to set the moving mode of the mobile power, the moving mode of the mobile power includes automatic tracking mode and manual manipulation mode, when the mobile power is set with the automatic tracking mode by the setting module, the controller controls the power housing to automatically follow the user according to the detecting result of the tracking device, when the mobile power is set with the manual manipulation mode by the setting module, the controller controls the power housing to move under the manipulations of the user according to the instructions received by the instruction receiving module.

11. The mobile power of claim 7, wherein the mobile power further comprises a pedal plate, the pedal plate is provided on the power housing for the user to stand on.

12. The mobile power of claim 7, wherein the mobile power further comprises a seat plate, the seat plate is provided on the power housing for the user to sit on.

13. The mobile power of claim 1, wherein the mobile power further comprises a solar panel, the solar panel is provided on the outer surfaces of the power housing, the solar panel is electrically connected with the battery pack.

14. The mobile power of claim 1, wherein the power housing is defined with a storage tank for accommodating articles including the electric tool.

15. A mobile power for outdoor power supply, comprising a power housing, a battery pack, a driving device, a controller and an instruction receiving module, wherein the battery pack is disposed inside the power housing, the power housing is provided with at least one socket electrically connected with the battery pack, the battery pack is used to supply electric power to an electric tool during outdoor work through the socket, the driving device includes wheels and driving motors for driving the wheels, the controller is connected with the driving motors, the instruction receiving module is connected with the controller, the instruction receiving module is used to receive instructions of the user, the controller controls the driving device to drive the power housing to move according to the instructions received by the instruction receiving module.

16. The mobile power of claim 15, wherein the mobile power further comprises a remote controller, the remote controller is matched with the instruction receiving module, the instruction receiving module receives the instructions sent by the user through the remote controller, the instruction receiving module sends the received instructions to the controller, the controller controls the driving device to drive the power housing to move according to the instructions of the user.

17. The mobile power of claim 15, wherein the mobile power further comprises a manipulating handle, the manipulating handle is provided on the power housing, the manipulating handle is connected with the instruction receiving module, the instruction receiving module receives the instructions sent by the user through the manipulating handle, the instruction receiving module sends the received instructions to the controller, the controller controls the driving device to drive the power housing to move according to the instructions of the user.

18. The mobile power of claim 15, wherein the mobile power further comprises a pedal plate, the pedal plate is provided on the power housing for the user to stand on.

19. The mobile power of claim 15, wherein the mobile power further comprises a seat plate, the seat plate is provided on the power housing for the user to sit on.

20. (canceled)

21. The mobile power of claim 15, wherein the power housing is defined with a storage tank for accommodating articles including the electric tool.
